(19) United States
(12) Patent Application Publication
(10) Pub. No.: US 2025/0082999 A1
(43) Pub. Date: Mar. 13, 2025

(54) SYSTEM FOR PAINTING GOLF BALLS

(71) Applicant: Acushnet Company, Fairhaven, MA (US)

(72) Inventors: Courtney N. Engle, Fall River, MA (US); Manjari Kuntimaddi, Raynham, MA (US)

(73) Assignee: Acushnet Company, Fairhaven, MA (US)

(21) Appl. No.: 18/367,148

(22) Filed: Sep. 12, 2023

(51) Int. Cl. A63B 45/02; B05B 12/08; B05B 13/02

(52) U.S. Cl. CPC A63B 45/02; B05B 12/082; B05B 12/084; B05B 13/0228; B05B 13/0278; A63B 37/0022

(57) ABSTRACT

A golf ball painting system encompassing a spray system having a spray gun configured to spray paint in a spray pattern toward an application area having one or more golf balls to be painted. The spray gun has one or more spray gun settings configured to be adjusted to thereby change the spray pattern of the sprayed paint. A spray control system is connected to the spray system. The spray control system has a spray gun control system configured to adjust or signal for adjustment of at least one of the one or more spray gun settings and a spray detection system having a detector positioned between the spray gun and the application area and configured to non-invasively monitor the spray pattern and collect data indicative of at least one spray pattern parameter. A device is configured to receive the at least one spray pattern parameter from the spray detection system and compare the at least one spray pattern parameter to a target value, and, if the at least one spray pattern parameter is outside of the target value, perform a corrective action.

### TECHNICAL FIELD

The present disclosure relates generally to a system for painting golf balls, and, more particularly, relates to a system for painting golf balls while monitoring the painting process and implementing feedback control.

### BACKGROUND OF THE INVENTION

Conventional golf balls generally include a core surrounded by a cover. The cover forms a spherical outer surface of the ball, and the surface includes a plurality of dimples. The core and/or the cover can be formed of a plurality of layers. The covers of typical golf balls are typically formed from a variety of materials, including polymers such as polyurethane and ionomer resins, depending upon the desired performance characteristics of the golf ball and desired properties of the cover.

Golf balls are produced in a variety of colors. Golf balls are most commonly made to have a white exterior appearance, but they may be manufactured with essentially any desired color. The color is imparted either by layers of paint applied to the outer surface of the ball or by incorporating a pigment directly into the cover composition (or both). Typically, in a painted ball, a first coat or primer layer of paint is applied, followed by a second, i.e., finishing coat or layer. After a ball has been colored, identifying indicia such as a trademark, logo, identification number, model name and/or number, and the like can be stamped or printed onto the ball. The indicia may be applied before or after the ball receives a finishing coat.

Golf balls should be capable of withstanding a variety of weather conditions such as sunlight, extreme temperature ranges, and immersion in water, preferably for an extended period. Further, the surface of a golf ball is flexed every time it is impacted with a club and, consequently, it must be able to withstand repeated stresses without damage to the cover. There are multiple sources of other types of degradation to the ball, for example, being struck with a grooved club head or landing on a rocky or abrasive surface such as a cart path. Resistance to such impact and abrasion is a desired feature of a golf ball. It is further desirable for manufacturers of golf balls that their golf balls be resistant to delamination or chipping of the paint layers, as aesthetic defects negatively impact the public perception of golf ball quality. Likewise, golf ball manufacturers prefer to protect trademarks, logos or other indicia, which identify the brand of the ball to the playing public.

Golf balls are, therefore, generally subjected to at least one clear or pigmented topcoat, primer coat, or other protective coat, which covers the golf ball outer surface in order to improve the overall appearance of the ball(e.g., high-gloss surface). In addition, a topcoat helps to protect any painted or primed layers and/or markings thereon from degradation during the golf ball's normal useful life. Such coatings can be applied as a single layer or as multiple layers.

Paint layers or protective coating materials can be applied by various methods. One such method uses a coating gun to spray the paint or coating material as atomized particles. In this method, an operator visually observes the spray as a ball is coated, determines whether the spray adequately coats the ball, and then manually changes the spray parameters, orientation, and/or location of the gun, as necessary. If the spray gun is ineffectively monitored or configured, a number of balls may be improperly coated as production proceeds, which could lead to increased manufacturing costs due to wasted materials. In some instances, a spray gun may malfunction or become clogged and result in partial spray which can lead to product waste, especially when not immediately noticed by an operator. Poor, inconsistent, or uneven paint coverage can also have a detrimental impact on the consistency of aerodynamic performance. In addition, an operator must shut down the line to make routine measurements (e.g., spray volume per pulse) and adjust the paint spray parameters if necessary, which leads to production inefficiencies due to line downtime.

The present disclosure addresses these and other golf ball paint system design factors in order to produce golf balls with consistent paint and coating coverage while maintaining efficient use of materials and operational time.

### SUMMARY

In some embodiments, a golf ball painting system includes a spray system including a spray gun configured to spray paint in a spray pattern toward an application area having one or more golf balls to be painted. The spray gun has one or more spray gun settings, configured to be adjusted to thereby change the spray pattern of the sprayed paint. A spray control system is connected to the spray system. The spray control system includes a spray gun control device configured to modify at least one of the one or more spray gun settings and a spray detection system having a detector positioned between the spray gun and the application area. The spray detection system is configured to non-invasively monitor the spray pattern and collect data indicative of at least one spray pattern parameter. A device is configured to receive the at least one spray pattern parameter from the spray detection system and compare the at least one spray pattern parameter to a target value, and, if the at least one spray pattern parameter is outside of the target value, perform a corrective action.

In other embodiments, a golf ball painting system includes a spray system including two spray guns, each configured to spray paint in a spray pattern toward an application area having a golf ball to be painted. The spray patterns of the two spray guns are generally conical and have a region of overlap in the application area, wherein the region of overlap has a width w given by 0.05d≤w≤0.25d, where d is the diameter of the golf ball, and wherein each spray gun has one or more spray gun settings configured to be adjusted to thereby change the spray pattern of the sprayed paint. A spray control system is connected to the spray system. The spray control system includes a spray gun control system configured to adjust at least one of the one or more spray gun settings of each spray gun. A spray detection system includes at least one detector positioned between the spray guns and the application area and is configured to non-invasively monitor the spray patterns of the two spray guns and collect data indicative of at least one spray pattern parameter. A device is configured to receive the at least one spray pattern parameter from the spray detection system and compare the at least one spray pattern parameter to a target value, and, if the at least one spray pattern parameter is outside of the target value, perform a corrective action.

In some other embodiments, a spray control system for a golf ball painting system includes a spray gun control device including a spray gun and a spray nozzle and is configured to produce a spray pattern dependent on at least one spray gun setting. A spray detection device is configured to collect data indicative of the spray pattern, and a feedback device is configured to determine a spray pattern parameter based on the collected data. A user device is configured to compare the spray pattern parameter to a target value, and, if the at least one spray pattern parameter is outside of the target value, perform a corrective action.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1A is a front view of a golf ball painting system, consistent with disclosed embodiments;

FIG. 1B is a top view of the golf ball painting system, further illustrating two offset spray guns, consistent with disclosed embodiments;

FIG. 1C is a schematic diagram of the golf ball painting system and further depicting exemplary interconnected systems, consistent with disclosed embodiments;

FIG. 2 is a system diagram of an exemplary spray control system, consistent with disclosed embodiments;

FIG. 3 is system diagram of an exemplary spray gun control device, consistent with disclosed embodiments;

FIG. 4 is a system diagram of an exemplary spray detection device, consistent with disclosed embodiments;

FIG. 5 is a system diagram of an exemplary feedback device and exemplary user device, consistent with disclosed embodiments;

FIG. 6 is a flowchart of an exemplary golf ball painting process, consistent with disclosed embodiments;

FIG. 7A is a diagram of a detection arrangement for a detector configured to monitor a target spray;

FIG. 7B is an example of a spray outline that may be determined based on data collected by the detector in FIG. 7A;

FIG. 7C is an example of a target spray outline that may be used by a feedback system to evaluate the spray outline of FIG. 7B to determine whether the spray in FIG. 7A is within a target standard, consistent with disclosed embodiments;

FIG. 8A is another diagram of a detection arrangement for a detector configured to monitor two target sprays at a first cut-through plane and a second cut-through plane;

FIG. 8B is an example of adjacent spray outlines that may be determined based on data collected by the detector in FIG. 8A at the first cut-through plane; and

FIG. 8C is an example of adjacent spray outlines that may be determined based on data collected by the detector in FIG. 8A at the second cut-through plane.

### DETAILED DESCRIPTION

Golf balls are generally spherical objects having multiple layers, usually including at least one core layer surrounded by a cover. In some golf balls, additional sprayed layers are applied to the cover. The additional layers may include, for example, one or more paint layers and/or one or more protective layers (i.e., a clear topcoat). A sprayed layer can be opaque and may include essentially any desired color or translucency. For example, a paint layer can contain colored dye or pigment and/or can have a specialized effect appearance. Sprayed layers can be glossy, matte, colored, etc. In one nonlimiting example, a first coat or primer layer of paint is applied, followed by a second or finishing coat. A clear coat protective layer may be applied on top of the paint layer(s). In order to efficiently produce large quantities of golf balls, the amount of time spent spraying paint and protective coatings is relatively short in duration. In one example of a painting process, two spray guns continuously spray paint in the direction of a moving line of rotating golf balls. If one or both of the spray guns are not precisely configured and properly functioning, paint may be wasted, product may be unfinished, and time may be lost. Furthermore, poor, inconsistent, or uneven paint coverage can also have a detrimental impact on the consistency of aerodynamic performance. Disclosed embodiments include a golf ball painting system that includes a spray control system that enables more efficient, consistent, and effective painting of large quantities of golf balls over a short period of time by actively monitoring a spray pattern and providing feedback to the spray control system, which may perform a corrective action.

In some embodiments, the present disclosure includes a golf ball painting system having hardware and software components configured to perform steps including executing a painting operation to apply paint and/or protective coatings to a plurality of golf balls, monitoring the painting operation and collecting information indicative of one or more parameters of the process, providing feedback to a control system based on the collected information, and adjusting the hardware and/or software components based on the feedback to enhance or improve the painting operation for further painting of golf balls. In some embodiments, monitoring the painting operation may include measuring or otherwise quantifying the results of a spraying operation (e.g., measure an applied coating parameter) and providing these results to the feedback system to further improve the painting process.

In some embodiments, a golf ball painting system includes a spray system having one or more spray guns configured to spray paint or protective coatings, a spray gun control device including the one or more spray guns and one or more controllable features for adjusting the spray guns, a spray detection device configured to collect data related to the output of the spray system, a feedback device configured to receive the collected data and provide instructions back to the spray control system, and a user device for analysis and feedback control. Some embodiments may also include a coating analysis system configured to measure or otherwise quantify a coating parameter of one or more golf balls which have been sprayed with at least one coating layer by the golf ball painting system.

Disclosed embodiments relate to spraying a material composition, such as paint, onto a golf ball. The term “spray” or “paint,” as used as a noun herein, is inclusive of pigmented and non-pigmented paints, can be considered a paint or a primer, and includes paints optionally infused with other materials such as silica or another mattifying agent, pearlescent or other color-effect particulate, and paints containing optical brightener. As used herein, the terms “spray” and “paint” are inclusive of sprayed protective coatings.

The term “spray” or “spraying” or “paint” or “painting” (as a verb) are contemplated to include the application of a material through a spray gun and/or spray nozzle. For example, spraying includes a process using pressurization to produce a particle and/or droplet flow through a nozzle into an application area where a material composition is deposited onto the surface of a golf ball. The material composition, as has been described herein, may be a paint, protective coating, or other material capable of being sprayed using a disclosed system.

The process of spraying produces a plume or “spray pattern” that is directed to the application area. The spray pattern can be quantified and used to define the flow and dispersal of particles and/or droplets that exit a nozzle. For example, the spray pattern may be defined by a plurality of spray parameters, including flow parameters (outlet volume, mass flow rate, velocity, etc.) and shape parameters (dispersal volume, area, cross-sectional shape, shape equation, particle/droplet size, particle/droplet count, etc.). In disclosed embodiments, a spray detection system is configured to detect one or more spray parameters to characterize a spray being monitored.

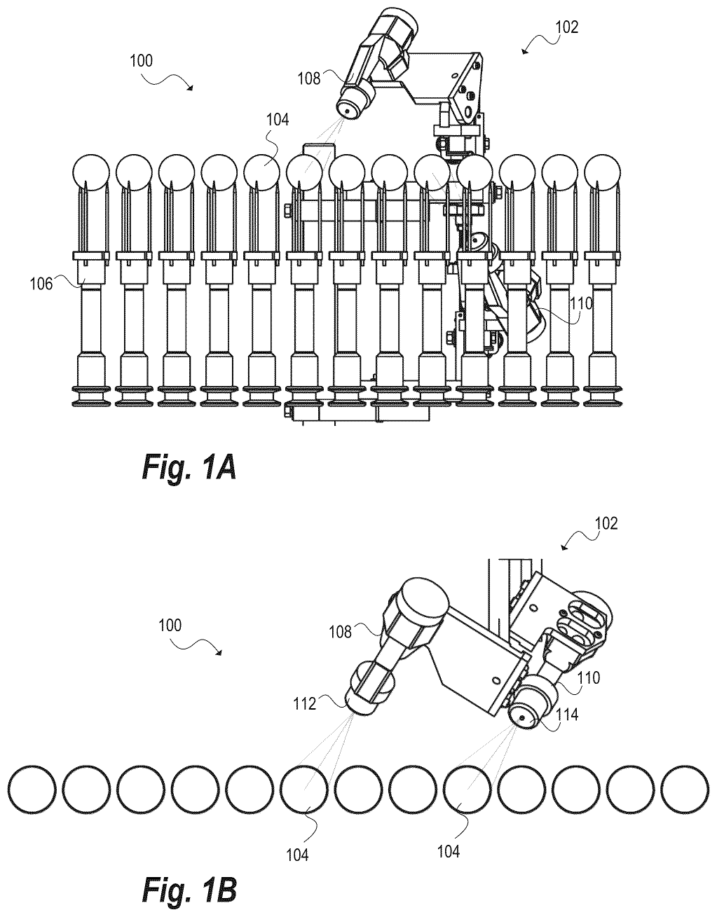

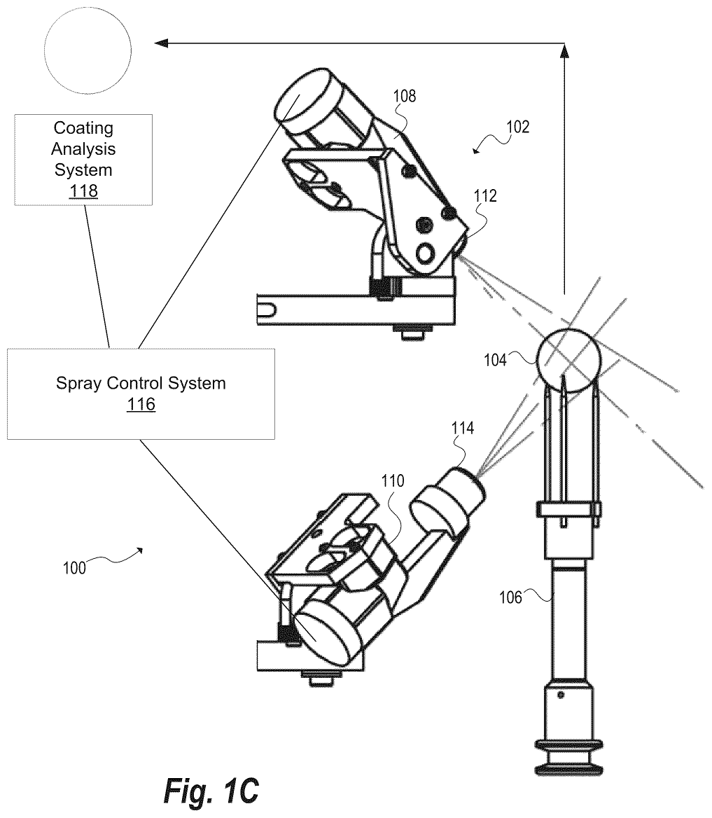

FIGS. 1A, 1B, and 1C depict an embodiment of a golf ball painting system 100. The golf ball painting system 100 includes a spray system 102 configured to spray golf balls 104. The portion of the spray system 102 shown in FIGS. 1A and 1B may be the same or similar to the spray system described in U.S. Patent Publication No. 2010/0151971 (U.S. application Ser. No. 12/336,728), which is hereby incorporated by reference in its entirety. The golf balls 104 may be supported and moved into an application area (i.e., a space at which they are reachable by sprayed paint) by spindles 106. The spindles 106 are arranged in a line and configured to move the golf balls 104 in a path past the spray system 102 as shown in FIG. 1B. In an exemplary embodiment, the spray system 102 includes a first spray gun 108 and a second spray gun 110. While the spray system 102 is depicted in FIGS. 1A-1C as having two spray guns 108, 110, it should be understood that other embodiments may include any number of spray guns. Each spray gun may be of a type that is commercially acceptable for painting golf balls. For example, each spray gun may be configured to receive a base material (e.g., paint) and direct the base material through a flow path that leads to a spray nozzle that atomizes or otherwise sprays the material toward an application area, in a manner known in the art. Each spray gun may include spray gun settings (e.g., volumetric flow rate through the spray gun, atomization pressure, etc.) that are adjustable in some manner, such as to alter the initial conditions of the material prior to exiting the associated nozzle. An ability to modify the spray gun settings enables the spray pattern exiting a spray nozzle to be altered or changed.

Each spray gun of the spray system 102 may be associated with an individual spray nozzle and may enable individual control and adjustment of the sprays released by the respective spray nozzles. For example, the spray gun 108 includes a spray nozzle 112 and the spray gun 110 includes a spray nozzle 114. In other embodiments, more than one spray nozzle is associated with the same spray gun. The spray guns 108, 110 may be adjustable through modifications to spray gun settings (e.g., by variation of the size and/or shape of an opening at the nozzle).

In an exemplary embodiment, the spray nozzle 112 and spray nozzle 114 are arranged at different angles relative to each other to produce spray patterns in different target areas. In an exemplary embodiment, the spray patterns generated by the spray nozzles 112, 114 are generally conical with elliptical spray pattern cross-sections. The elliptical cross-sections may have a major axis a satisfying 0.75d≤a≤4d and a minor axis b satisfying 0.2d≤b≤1.5d where d is the diameter of the golf ball. The spray pattern of each spray gun may be configured such that the elliptical cross-section has a major axis which is horizontal or vertical. In other embodiments, the spray pattern may be skewed such that the major axis of the elliptical cross-section is neither horizontal nor vertical.

For example, the first spray gun 108 may be configured to spray in an area generally toward the top half of the golf balls 104, while the second spray gun 110 may be configured to spray in an area generally near the bottom half of the golf balls 104 as they move in a path past the spray system 102. The spray nozzles 112, 114 may be offset from each other in multiple dimensions in order to produce spray patterns at different points along the path of the golf balls 104, as shown in FIGS. 1A and 1B. The spray guns 108, 110 may be configured such that the spray patterns exiting the spray nozzles 112, 114 have a region of overlap that is coincident with an area generally surrounding the great circle of the golf ball 104 that is lying in a plane that is orthogonal to the axis of rotation of the spindle 106. In other words, the spray guns 108, 110 overlap near the middle of the golf balls 104 such that some surface area portions of the golf balls 104 receive paint from both spray guns 108, 110. In one example, the region of overlap has a width w given by 0.05d≤w≤0.25d where d is the diameter of the golf ball 104.

FIG. 1C is a schematic diagram showing an embodiment of the golf ball painting system 100 in which the spray system 102 is connected to a spray control system 116. In an exemplary embodiment, the spray control system 116 is configured to electronically and/or mechanically control the spray guns 108, 110 in order to affect one or more parameters of the paint that exits the spray nozzles 112, 114. For example, the spray control system 116 may include an on/off status adjustment to start and stop the flow of paint through the spray guns 108, 110. In another example, the spray control system 116 may include an on/off status adjustment to start and stop the movement of the golf balls into and out of the application area. In another example, the spray control system 116 may include an electronic or mechanical control to adjust the pressure at the spray nozzles 112, 114 to thereby adjust the flow rate of the sprayed paint. In another example, the spray control system 116 may include an electronic or mechanical control to adjust the size or shape of the spray nozzles 112,114 to thereby adjust the spray pattern of the sprayed paint. In some embodiments, the spray control system 116 may be configured to transmit an alert or message to a user to manually adjust the spray system configuration. In some embodiments, the spray control system 116 is configured to receive electronic control instructions and produce signals that automatically adjust one or more parameters of a spray gun 108 and/or 110.

In some embodiments, the spray control system 116 is connected to a coating analysis system 118. The coating analysis system 118 may be configured to measure and/or receive information about a coating layer that has already been applied to a golf ball. The information about a coating layer may be a coating parameter. The coating parameter may be a quantitative and/or qualitative metric of a sprayed coating applied to a golf ball. For example, the coating parameter may be a coat weight or coat thickness (layer thickness) of a sprayed paint layer. In another example, the coating parameter may be a rating of a paint coverage of the golf ball (e.g., a percentage of surface area covered by an applied coating, coating evenness, evidence of pooling, and/or the results of a manual visual rating.). In some embodiments, the coating analysis system 118 is a computing device that receives a coating parameter and provides the data to the spray control system 116. In some embodiments, the coating analysis system 118 is a component (e.g., computing module) of the spray control system 116. The coating analysis system 118 may also receive contextual information such as a time in which the golf ball was sprayed with the measured coating such that the spray control system 116 can associate the measured coating parameter with the parameters of the spray that resulted in the coating. The coating analysis system 118 may also signal a need to manually inspect certain golf balls if a measured parameter falls outside of a specified range.

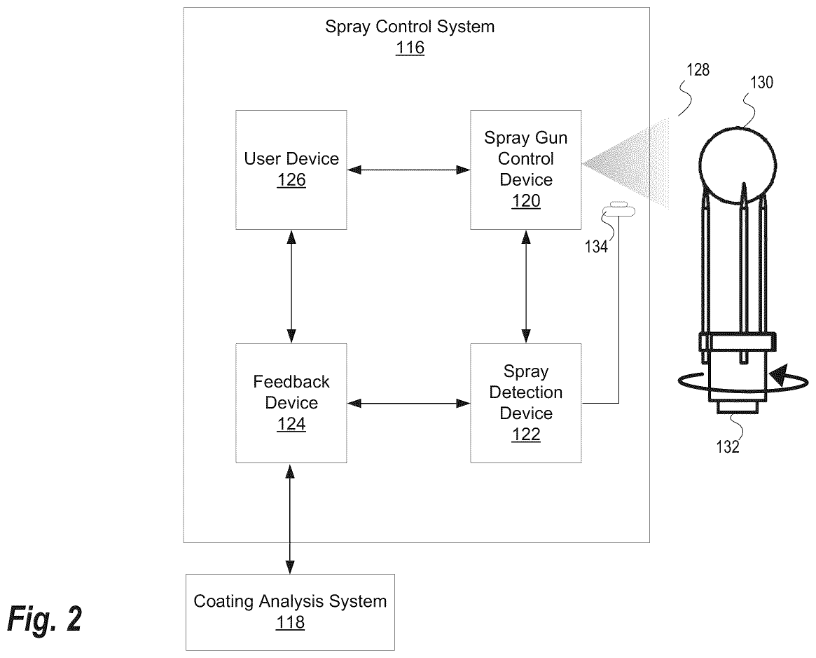

FIG. 2 is a diagram of an embodiment of the spray control system 116. The spray control system 116 may include hardware and/or software components configured to perform one or more processes associated with painting golf balls via one or more spray guns. The spray control system 116 may include at least some components of the spray system 102. For example, the spray guns 108, 110 and spray nozzles 112, 114 may be considered components of the spray control system 116 in some embodiments. In an exemplary embodiment, the spray control system 116 includes a spray gun control device 120, a spray detection device 122, a feedback device 124, and a user device 126.

In an exemplary embodiment the spray gun control device 120, spray detection device 122, feedback device 124, and user device 126 are connected to each other electronically and mechanically. While these device components of the spray control system 116 are depicted and described as separate, it should be understood that one or more of the underlying components may be combined in some embodiments. For example, the spray control system 116 may be considered a single device with one or more components shared across the devices described herein.

At least one of the spray guns 108, 110 and spray nozzles 112, 114 is connected to and/or part of the spray gun control device 120 and produces a spray 128. One of ordinary skill in the art will understand that the use of “spray” or “paint” as inclusive of both continuous and non-continuous spray. The spray 128 is directed toward an application area to paint a golf ball 130 on a spindle 132 passing through the application area. The spindle 132 may be configured to rotate to expose different portions of the golf ball 130 to the spray 128 exiting the spray gun control device 120. The spray gun control device 120 further includes one or more adjustment features configured to enable a modification to at least one parameter of the spray 128 (e.g., to alter or change the associated spray pattern).

The spray detection device 122 is configured to monitor the spray 128 and includes one or more detectors 134 configured to collect data indicative of a parameter of the spray 128. While one detector 134 is shown, it should be understood that the spray detection device 122 may employ a plurality of detectors 134, such as one detector for each spray gun (e.g., two detectors for the two spray guns 108, 110). The spray detection device 122 may be further configured to format and provide collected data to the feedback device 124. The feedback device 124 is configured to receive data from the spray detection device 122 and provide information back to the user device 126 and/or the spray gun control device 120 in order to produce a corrective action based on data collected by the spray detection device 122. In some embodiments, the feedback device 124 is also connected to the coating analysis system 118 to receive information regarding measured coating parameters of golf balls that have been painted by the spray 128.

The feedback device 124 is configured to produce a communication loop to provide information about the spray 128 back into the spray control system 116 for use by the spray control system 116 and/or an end user. In one embodiment, the feedback device 124 may enable the spray control system 116 to alert a user to a spray pattern deviation or error. In another embodiment the feedback device 124 may enable the spray control system 116 to make automatic adjustments to the spray system 102 via the spray gun control device 120 in order cease a spray that is not performing to a standard and/or modify the spray to cause it to perform at said standard.

In some embodiments, the connection between the spray gun control device 120, the spray detection device 122, and the feedback device 124 enables the spray control system 116 to perform a calibration method that relates spray parameters to spray gun settings. By varying the spray gun settings while monitoring the resulting spray pattern, the spray control system 116 can learn how different spray gun settings affect spray pattern parameters. The feedback device 124 may be configured to generate a spray pattern algorithm that relates adjustments in spray gun settings (e.g., gun pressure, nozzle setting, and/or flow rate to nozzle.) to spray parameters (e.g., outlet pressure volume, paint mass flow rate, particulate and/or paint flow velocity, dispersal volume, spray area, spray cross-sectional shape, and/or shape equation) such that given adjustments to spray gun settings would produce predictable changes to spray parameters. In a particular embodiment, the algorithmic predictions for adjustment are conveyed to a user for manual adjustment of the system. In another particular embodiment, these algorithmic predictions are used for automatic adjustment to the spray gun system.

Further, in some embodiments, the connection of the feedback device 124 to the coating analysis system 118 produces an additional communication loop for more robust control by the spray gun control device 120. In some embodiments, the connection between the feedback device 124 and the coating analysis system 118 enables the spray control system 116 to perform another calibration method that relates spray parameters collected by the spray detection device 122 to measured coating parameters received by the coating analysis system 118. In other words, the spray control system 116 may be configured to learn via feedback how the particular parameters of the spray 128 from a spray gun affect the actual coating results on a painted golf ball. In this way, the spray control system 116 can optimize efficiency in the use of paint and in quality and consistency of paint application. In some embodiments, the spray control system 116 is configured to use feedback from the spray detection device 122 and the coating analysis system 118 to determine a spray control algorithm that relates spray pattern parameters to measured coating parameters and outputs spray control instructions to adjust a spray pattern based upon measured parameters to more closely match an ideal pattern.

The user device 126 may enable a user and/or other device within or connected to the spray control system 116 to provide input and output to and/or from the spray control system 116. The user device 126 may be a computing device configured to produce a user interface to provide detection data (e.g., spray images), alerts, and other information to a user regarding the spray 128. The user device 126 may further enable the user to provide manual input to adjust one or more aspects of the spray control system 116 (e.g., to stop and start the spray 128 and/or to make a configuration adjustment to the spray system 102).

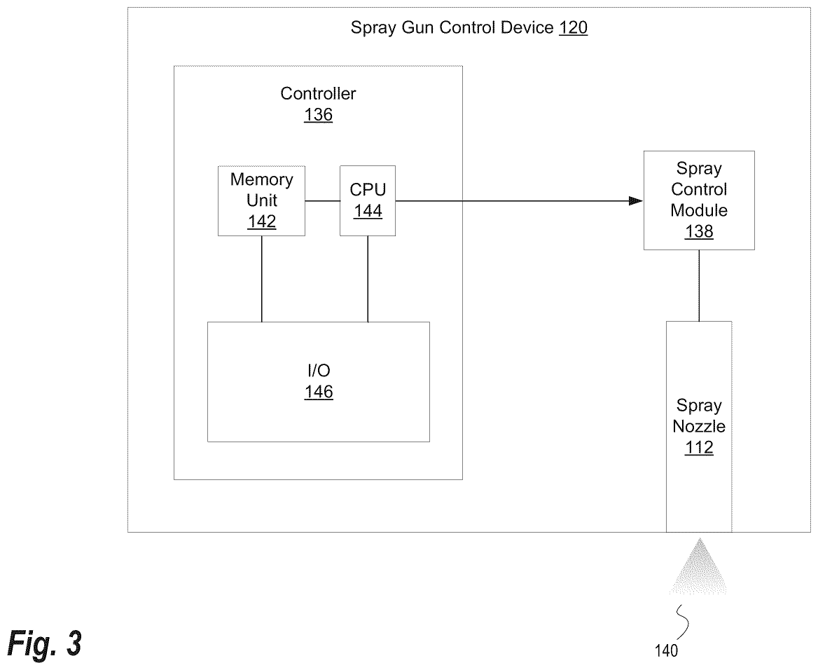

FIG. 3 is a diagram of an exemplary embodiment of the spray gun control device 120. The spray gun control device 120 may be a computing device including hardware and/or software components configured to perform one or more steps in a process of spray painting golf balls. For example, the spray gun control device 120 may be a computer such as a desktop, laptop, server, etc. that includes a controller 136 and a spray control module 138. The spray gun control device 120, in the embodiment depicted, includes and/or is connected to the spray nozzle 112 to produce a spray pattern 140. It should be understood that the spray gun control device 120 may be connected to any spray gun and/or spray nozzle contemplated by the present disclosure.

The controller 136 may include a memory unit 142, a central processing unit (CPU) 144, and an input/output (I/O) 146. The CPU 144 may be configured to execute software instructions, such as those stored in the memory unit 142, to perform one or more functions. The I/O 146 may be a hardware and/or software communications component, such as a user interface, peripheral device, network connection, etc., that enables the controller 136 to provide instructions to the spray control module 138 to adjust one or more spray gun settings.

The spray control module 138 may be a hardware and/or software component configured to control one or more aspects of a spray associated with the spray gun 108 and/or spray nozzle 112. For instance, the spray control module 138 may be configured to provide electronic instructions that cause mechanical adjustment of a spray gun setting (e.g., volumetric flow rate to the spray nozzle 112 and/or atomization pressure at the spray nozzle 112) to thereby adjust or change the spray pattern 140. In some embodiments, the spray control module 138 may also be configured to signal a need to manually adjust the spray system configuration. In an exemplary embodiment, the controller 136 is configured to receive instructions to communicate to the spray control module 138 for adjusting one or more spray gun settings, such as adjustment to a mechanism for controlling volumetric flow rate and/or a mechanism for controlling atomization pressure. In one example, the controller 136 may receive initial spray gun settings for volume. pressure, nozzle position, flow rate, etc. that dictate a first spray pattern 140 from the spray nozzle 112 when the spray gun 108 is activated.

While the spray gun control device 120 is described as a computing component in some embodiments, it should be understood that the present disclosure contemplates a spray control system 116 that is connected to a manually-adjustable spray gun. The spray gun control device 120 in these embodiments, may be, for example, a mechanical adjustment knob or a nozzle which itself is manually adjustable (e.g., the size and/or shape of an opening of the nozzle can be varied).

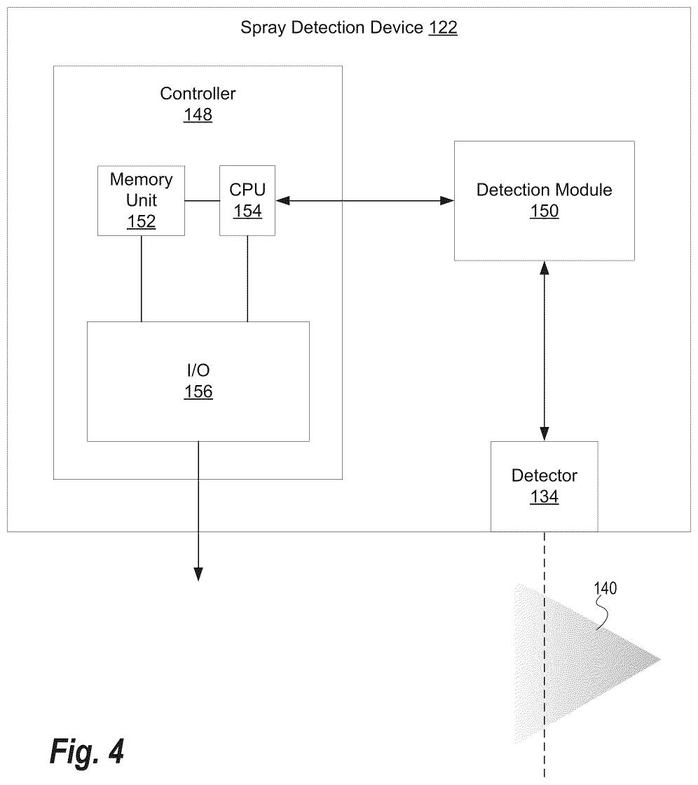

FIG. 4 is a diagram of an exemplary embodiment of the spray detection device 122. The spray detection device 122 is configured to monitor and collect data (e.g., spray parameters) associated with the spray pattern 140. The spray detection device 122 may be a computing device including hardware and/or software components configured to perform one or more steps in a process of spray painting golf balls. For example, the spray detection device 122 may be a computer such as a desktop, laptop, server, etc. that includes a controller 148, a detection module 150, and connection to the detector 134. The controller 148, like the controller 136 in the spray gun control device 120, may be a computing device including a memory unit 152, a CPU 154, and an U/O 156. The CPU 154 may be configured to execute software instructions, such as those stored in the memory unit 152, to perform one or more functions. The I/O 156 may be a hardware and/or software communications component such as a user interface, peripheral device, network connection, etc., that enables the controller 148 to send and receive instructions to interconnected components and devices. In some embodiments, the detector 134 may be directly connected via the I/O 156 (e.g., at a mechanical and/or virtual port).

The detection module 150 may be a software and/or hardware component configured to deliver control instructions to the detector 134 (e.g., turn on/turn off, power setting, and/or field-of-view or field-of-detection settings, etc.). The detection module 150 may be further configured to receive data gathered by the detector 134 and send the collected data to the controller 148 for further use in the spray control system 116.

The detector 134 is configured to monitor the spray pattern 140 exiting a spray nozzle. The detector 134 is a non-invasive fluid flow detection device positioned between a spray gun and a golf ball with a field of view directed toward a spray. The detector 134 is configured to collect data indicative of spray parameters of the spray pattern 140 and provide the data to other devices in the spray control system 116 through the detection module 150 and the controller 148. The data collected on a particular spray includes one or more spray parameters. Examples of spray parameters include flow parameters (e.g., outlet volume, mass flow rate, and/or velocity) and/or shape parameters (dispersal volume, area, cross-sectional shape, shape equation, particle/droplet size, particle/droplet count, particle/droplet shape, etc.).

In some embodiments, one or more components of the spray control system 116, including the spray detection device 122 and the detector 134, are provided in the form of a spray imaging system available on the market. Spray imaging systems that may be configured to perform one or more of the disclosed functions are available from various companies including, for example, LaVision Inc., Spray Systems Co., Cavitar Ltd., among others. For instance, LaVision Inc. produces the SprayMaster™ device, which measures spray pattern and spray plume geometry, and the ParticleMaster device, which detects drop/particle size, shape, and velocity. Available devices may utilize a lighting scheme, such as a light sheet, back light, and/or front light, to enhance the ability of the system to accurately detect and collect data reflecting a spray pattern. One of ordinary skill in the art would understand that multiple spray imaging systems can be combined in the spray control system 116.

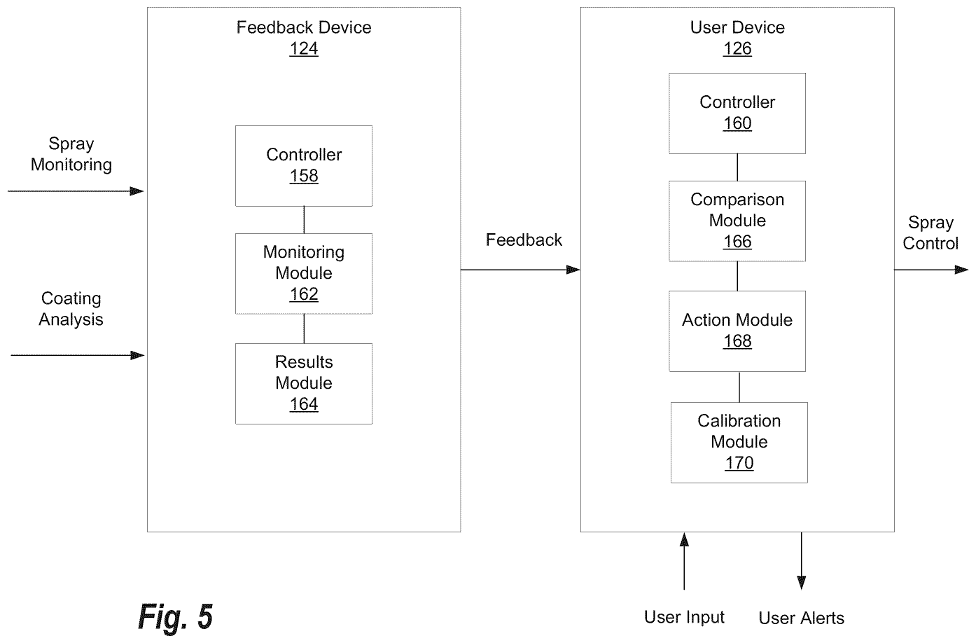

FIG. 5 is a detailed diagram of exemplary embodiments of the feedback device 124 and the user device 126. The feedback device 124 and user device 126 may be separate or combined computing devices such as a desktop, laptop, server, etc. The feedback device 124 includes a controller 158, and the user device 126 includes a controller 160 (a combined feedback/user device may share one controller). The controllers 158, 160 may be the same as or similar to the controllers 136, 148 previously described and include a memory unit, CPU, and I/O. The controller 160, for example, may be connected with a user interface to receive user input, such as spray gun settings, from a user. The controller 160 may be further connected with the spray gun control device 120 to deliver and enact the spray gun settings. The feedback device 124 and user device 126 may further include a plurality of software and/or hardware modules that are connected to and/or part of the controllers 158, 160 for performing the steps of one or more disclosed processes.

In some embodiments, the feedback device 124 includes a monitoring module 162 and a results module 164. The monitoring module 162 may be configured to receive data collected by the spray detection device 122. For example, the monitoring module 162 may be configured to receive imaging data from the spray detection device 122. The monitoring module 162 may format the collected data so that it can be displayed as images by the user device 126 to a user. The results module 164 may be configured to receive coating parameter information from the coating analysis system 118. As a result, data regarding the results of a spraying operation can be introduced into the communication loop of the spray control system 116. The monitoring module 162 and the results module 164 may be configured to provide the received data as feedback to the user device 126.

According to some embodiments, the user device 126 includes at least a comparison module 166, an adjustment module 168, and a calibration module 170. The comparison module 166 may compare feedback information received from the feedback device 124 to one or more stored thresholds to determine whether a target or tolerance has been breached. For example, if the monitoring module 162 delivers a spray parameter that is outside of an established threshold or the results module 164 delivers a coating parameter that is outside of an acceptable value, the comparison module 166 may determine that a condition exists for performing a corrective action. For example, the comparison module 166 may determine that a shape of a monitored spray pattern has deviated from an expected target and perform a corrective action in the form an alert to the action module 168 and may optionally provide data regarding the deviation. The action module 168 may be configured to receive information from the comparison module whenever a target or threshold has been breached and perform a corrective action in the form of a user alert (e.g., a flashing light and/or an audible sound) and/or an instruction to the spray gun control device 120 for adjusting a spray gun setting (e.g., shutting down the spray gun or changing a setting such as volume or pressure). The corrective action may also include starting and stopping the movement of the golf balls into and out of the application area.

The calibration module 170 is in communication with the controller feedback device 124, the controller 160, the comparison module 166, and the action module 168. The calibration module 170 may be configured to use data from one or more of these connected components to perform a calibration process that may be used to set up and operate the disclosed spray control system 116. The calibration module 170 may be configured to generate a spray pattern algorithm and/or a spray control algorithm. The calibration module 170 may generate the spray pattern algorithm based on spray gun settings and detected spray pattern parameters. The calibration module 170 may generate a spray control algorithm based on the spray pattern algorithm (or only its variables of spray gun settings and detected spray parameters) and collected coating parameters. The spray pattern algorithm may provide a mechanism for determining a spray gun setting adjustment to achieve a particular spray pattern parameter. For example, a spray pattern parameter y (e.g., a spray pattern shape) may be defined by a function F(x) where x is at least one spray gun setting such as nozzle supply pressure. The spray control algorithm extends this relationship to the results of spray painting golf balls to determine how changes in spray pattern parameters affect the goal of efficient and effective paint coverage on the golf balls. The spray control algorithm may be defined as a control function C(x, y, z) which is based on one or more spray gun settings x, one or more spray pattern parameters y, and one or more measured or otherwise collected coating parameters (e.g., coating weight, thickness, and/or coverage rating).

In some embodiments, the comparison module 166 and/or action module 168 may be configured to use a spray pattern algorithm and/or spray control algorithm generated by the calibration module 170. For example, the comparison module 166 may determine that a detected spray pattern parameter is outside of a target range, and the action module 168 may input the detected parameter into a spray pattern algorithm to determine how to adjust the spray gun settings to move the detected parameter into the target range.

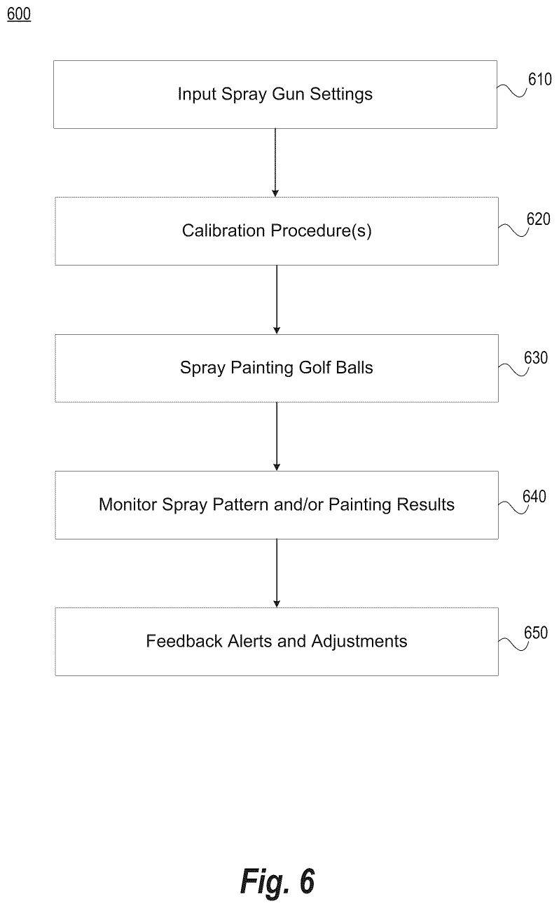

FIG. 6 is a flow chart of an exemplary process 600 for painting golf balls using the golf ball painting system 100 and the spray control system 116. In one embodiment, the process 600 includes setting initial spray gun settings in step 610. For example, a spray gun may be positioned and activated for use in painting golf balls. In some embodiments, the spray gun control device 120 may provide electronic instructions to the spray gun for implementing the spray gun settings. The spray gun settings may include supply pressure, nozzle position, etc.

The process 600 may further include performing a calibration procedure in step 620. The calibration procedure may be a step in which a spray pattern algorithm or relationship is determined. For example, spray gun settings may be varied while data is collected by the spray detection device 122. The spray gun settings may be locked in to values when a target spray pattern is achieved (e.g., as detected by the spray detection device 122). In another example, the step 620 may include generating a spray control algorithm that relates the quality of painted golf balls with spray gun settings and/or spray pattern parameters. In some embodiments, the step(s) 620 may be continuously performed as process 600 continues in order to build upon and update the spray pattern and/or spray control algorithms as more data is collected.

The process 600 further includes the spray control system 116 spray painting golf balls in step 630. For example, as shown in FIGS. 1A-1C, the spray system 102 may utilize one or more spray guns 108, 110 to paint passing and rotating golf balls 104. While step 630 is ongoing, the spray control system 116 monitors spray parameters in step 640. For example, the spray detection device 122 may continuously collect data associated with a monitored spray pattern produced in step 630. The spray detection device 122 may collect the data and deliver the spray pattern parameters to the feedback device 124. In some embodiments, step 640 also includes the feedback device 124 additionally receiving data related to the results of step 630 via the coating analysis system 118. For example, the feedback device 124 may receive one or more coating parameters that quantitatively and/or qualitatively measure a coating that has already been sprayed on a golf ball.

In step 650, the spray control system 116 uses feedback control to determine whether to perform a corrective action, such as alerting the user to a spray condition and/or adjusting a spray gun setting. For example, the user device 124 may receive spray pattern parameters and compare the parameters to a target threshold and/or range.

In one example, the spray control system 116 is configured to detect a spray pattern shape and compare the spray pattern shape to a target shape to determine whether the spray deviates from the target shape beyond a threshold. In another example, the spray control system 116 is configured to receive droplet size and shape data and determine a mass flow rate of paint from the spray nozzle into the application area. The spray control system is configured to compare the mass flow rate to a target mass flow rate to determine whether the spray deviates from a target threshold. These are only some examples of spray pattern parameters that may be detected and compared to a threshold and should be considered nonlimiting.

If the detected parameters are outside of the target, the user device 124 may provide an alert to a user and/or deliver a spray adjustment instruction to the spray gun control device 120 (e.g., to shut down the spray gun, to stop the movement of the golf balls into and out of the application area, to inspect and/or discard any partially sprayed golf balls, or to otherwise change a spray gun setting). In some embodiments, the detected spray pattern parameters are further used to determine what corrective action should be performed. For instance, the spray pattern parameters may be used to determine a target spray pattern parameter change. The target spray pattern parameter change may be converted to a change or changes in spray gun settings based on a spray pattern algorithm determined in a calibration procedure. In some embodiments, one or more of those changes can be communicated to a user, providing instructions on manual spray system adjustment. In some embodiments, one or more of those changes can be automatically adjusted by the spray control system 116.

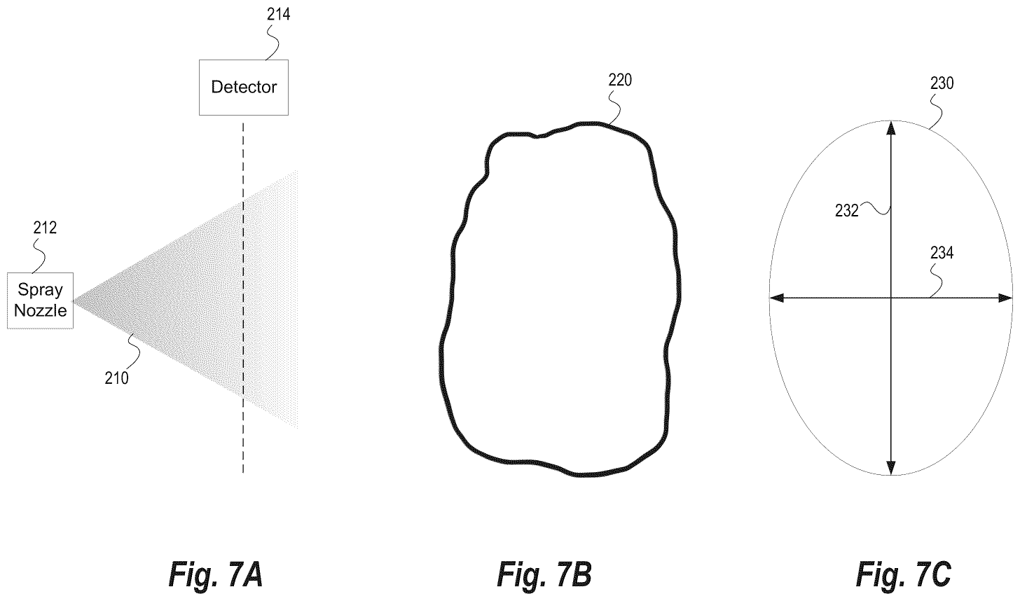

FIGS. 7A, 7B, and 7C depict one example of a spray pattern monitoring scheme that may be implemented into the spray painting process 600. FIG. 7A shows an example of a spray 210 from a spray nozzle 212 with a detector 214 positioned in a non-invasive position to not interfere with the spray 210 or spray nozzle 212. The detector 214 may be the same as or similar to the detector 134 and may be connected to and/or a part of the spray control system 116. The spray 210 may be continuous or non-continuous depending on the operation of the spray gun associated with the spray nozzle 212.

In an exemplary embodiment, the spray 210 has a generally conical shape (i.e., as a typical spray plume expands radially from the site of the spray nozzle) such that a cross-section of the spray 210 is generally elliptical. The term generally conical, as used herein, includes shapes that expand from a single outlet point, such as a nozzle, and encompasses shapes having a cross-sectional geometry that may additionally or alternatively be considered less circular or more polygonal. In some embodiments, the detector 214 is configured to monitor and detect a shape of a cross-section of the spray 210, such as the generally elliptical outline 220 shown in FIG. 7B. In other embodiments, the detector 214 is configured to measure droplet size and/or droplet count as a characterization of the spray 210.

The spray control system 116 is configured to receive data indicative of the elliptical outline 220 (e.g., image data) and use the information as a spray pattern parameter to assess the performance of the spray 210. For example, the spray control system 116 may store a target shape 230, depicted in FIG. 7C. The target shape 230 may be an ellipse having a major axis 232 and a minor axis 234. The spray control system 116 may be configured to compare the elliptical outline 220 to the target shape 230 and determine whether the spray 210 is within a specified tolerance (e.g., to assess similarity to the target shape 230) or whether the spray 210 is outside of the target range.

In some embodiments, the spray control system 116 is configured to determine the target shape 230 based on one or more constant values. For instance, the spray control system 116 may set the target shape to be an ellipse with a major axis a 232 satisfying 0.75d≤a≤4d and a minor axis b 234 satisfying 0.2d≤b≤1.5d where d is the diameter of the golf ball being painted.

FIGS. 7A-7C depict a situation in which a single detector monitors a single spray. In exemplary embodiments having more than one spray gun, separate detectors may be associated with each spray gun. In other embodiments, a detector may monitor a combined spray pattern from more than one spray gun, or the data collected from multiple detectors may be analyzed in combination.

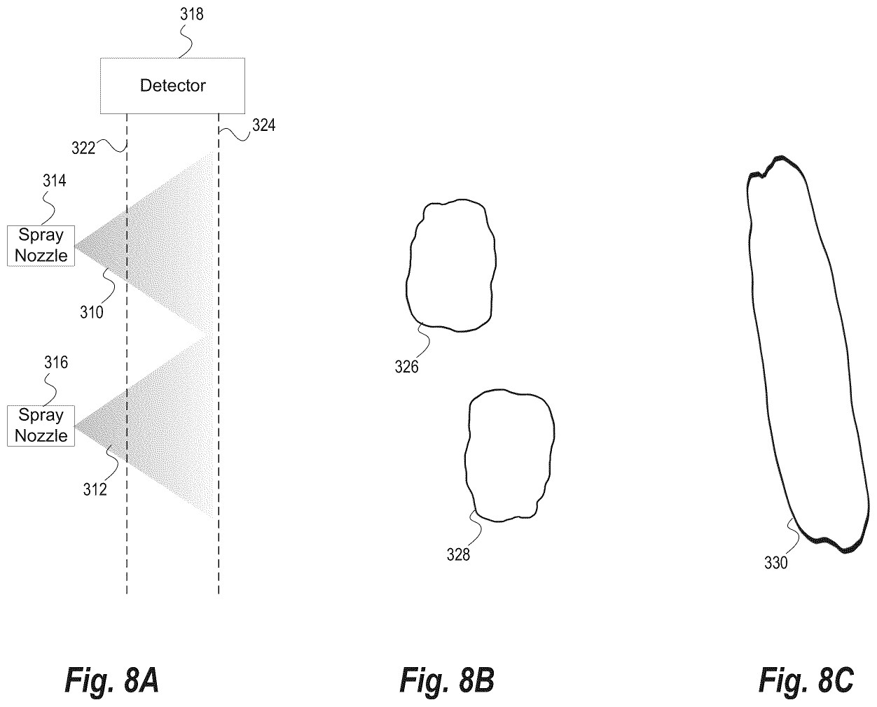

FIGS. 8A, 8B, and 8C depict another example of a spray pattern made up of two sprays 310, 312 from two spray nozzles 314, 316, respectively. A detector 318 is positioned between the spray nozzles 314, 316 and configured to non-invasively monitor the sprays 310, 312 at both or either of a first cut-through plane 322 and/or a second cut-through plane 324. The first cut-through plane 322 is positioned closer to the spray nozzles 314, 316 while the second cut-through plane 324 is positioned closer to the object of application of the sprays 310, 312 (i.e., the second cut-through plane 324 is closer to the position of the golf balls being painted than the first cut-through plane 322). The detector 318 is configured to capture spray pattern parameters indicative of the cross-sectional shapes of the sprays 310, 312 at the first cut-through plane 322 and the second cut-through plane 324.

FIG. 8B is an example depiction of two spray outlines 326, 328 that may be detected by the detector 318 at the first cut-through plane 322. The two spray outlines 326, 328 are spaced from each other because the first cut-through plane 322 occurs before the two sprays 310, 312 begin to overlap. At this cross-section, the spray control system 116 may determine one or more spray pattern parameters that characterize both of the sprays 310, 312. For instance, the spray control system 116 may be configured to determine spray parameter information such as cartesian or radial coordinate spacing of the shape outlines 326, 328 and compare that information to expected spacing to determine whether the two sprays 310, 312 are within tolerance.

FIG. 8C is a depiction of a combined spray outline 330 that may be detected by the detector 318 at the second cut-through plane 324. The combined spray outline 330 is a single outline defined by the two sprays 310, 312 because the second cut-through plane 324 occurs downstream after the two sprays 310, 312 begin to overlap. At this cross-section the spray control system 116 may determine one or more spray parameters that characterize both of the sprays 310, 312 by comparing the combined spray outline 330 to a target shape for the combined sprays. The spray control system 116 may determine whether the combined spray outline 330 is within a tolerance in comparison to the target shape.

Some embodiments of the present disclosure may include a computer-implemented method for painting golf balls. The method may include moving a plurality of golf balls to be painted into an application area and spraying paint in a spray pattern toward the application area by a spray system. The spray system may include a spray gun having one or more spray gun settings configured to be adjusted by a spray gun control device to thereby change the spray pattern. The method may also include monitoring the spray pattern by a spray detection system. The spray detection system may include a detector positioned between the spray gun and the application area to collect data indicative of at least one spray pattern parameter. The method may further include receiving the data indicative of at least one spray pattern parameter at a processing device, comparing, by the processing device, the at least one spray pattern parameter to a target value, determining, by the processing device, that the at least one spray pattern parameter is outside of the target value, and performing, by the processing device, a corrective action based on the at least one spray pattern parameter being outside of the target value.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all modifications and embodiments which would come within the spirit and scope of the present invention.

What is claimed is:

1. A golf ball painting system comprising:
a spray system comprising a spray gun configured to spray paint in a spray pattern toward an application area having one or more golf balls to be painted, wherein the spray gun has one or more spray gun settings configured to be adjusted to thereby change the spray pattern of the sprayed paint; and
a spray control system connected to the spray system, the spray control system comprising:
a spray gun control device configured to modify at least one of the one or more spray gun settings;
a spray detection system comprising a detector positioned between the spray gun and the application area and configured to non-invasively monitor the spray pattern and collect data indicative of at least one spray pattern parameter, and
a device configured to receive the at least one spray pattern parameter from the spray detection system and compare the at least one spray pattern parameter to a target value, and, if the at least one spray pattern parameter is outside of the target value, perform a corrective action.

2. The golf ball painting system of claim 1, wherein the spray pattern is generally elliptical with a major axis a satisfying 0.75d≤a≤4d and a minor axis b satisfying 0.2d≤b≤1.5d where d is the diameter of the golf ball.

3. The golf ball painting system of claim 1, further comprising a plurality of golf balls, each supported on a spindle, wherein the spindles are configured to rotate the golf balls while in the application area.

4. The golf ball painting system of claim 1, wherein the corrective action is providing an alert to a user.

5. The golf ball painting system of claim 1, wherein the corrective action is adjusting the one or more spray gun settings.

6. The golf ball painting system of claim 5, wherein the spray gun comprises a mechanism for adjusting a volumetric flow rate to a nozzle of the spray gun, and the one or more spray gun settings include the volumetric flow rate.

7. The golf ball painting system of claim 5, wherein the spray gun comprises a mechanism for adjusting an atomization pressure at a nozzle of the spray gun, and the one or more spray gun settings include the atomization pressure.

8. The golf ball painting system of claim 5, wherein the spray gun comprises a mechanism for turning off the spray gun, and the one or more spray gun settings comprise an on/off status of the spray gun.

9. The golf ball painting system of claim 1, wherein the spray pattern parameter is at least one of a flow parameter or shape parameter.

10. A golf ball painting system comprising:
a spray system comprising two or more spray guns, each configured to spray paint in a spray pattern toward an application area having a golf ball to be painted, wherein the spray patterns of the two or more spray guns are generally conical and have a region of overlap in the application area, wherein the region of overlap has a width w given by 0.05d≤w≤0.25d, where d is the diameter of the golf ball, and wherein each spray gun has one or more spray gun settings configured to be adjusted to thereby change the spray pattern of the sprayed paint; and
a spray control system connected to the spray system, the spray control system comprising:
a spray gun control device configured to adjust at least one of the one or more spray gun settings of each spray gun,
a spray detection system comprising at least one detector positioned between the spray guns and the application area and configured to non-invasively monitor the spray patterns of the two or more spray guns and collect data indicative of at least one spray pattern parameter,
a device configured to receive the at least one spray pattern parameter from the spray detection system and compare the at least one spray pattern parameter to a target value, and, if the at least one spray pattern parameter is outside of the target value, perform a corrective action.

11. The golf ball painting system of claim 10, wherein the spray detection system comprises two or more detectors, at least one for each of the two or more spray guns.

12. The golf ball painting system of claim 10, wherein the golf ball is positioned on a spindle configured to rotate about an axis, and wherein the region of overlap is coincident with an area surrounding the great circle lying in the plane that is orthogonal to the axis of rotation.

13. The golf ball painting system of claim 12, wherein the at least one spray parameter is a coordinate spacing between the spray patterns produced by the two spray guns, wherein the spacing occurs prior to the region of overlap.

14. The golf ball painting system of claim 12, wherein the at least one spray parameter is a combination of a cross-sectional shape of the spray patterns produced by the individual spray guns and the combined cross-sectional shape including the region of overlap.

15. A spray control system for a golf ball painting system, the spray control system comprising:
a spray gun control device comprising a spray gun comprising a spray nozzle and configured to produce a spray pattern dependent on at least one spray gun setting;
a spray detection device configured to collect data indicative of the spray pattern;
a feedback device configured to determine a spray pattern parameter based on the collected data; and
a user device configured to compare the spray pattern parameter to a target value, and, if the at least one spray pattern parameter is outside of the target value, perform a corrective action.

16. The spray control system of claim 15, wherein the user device is configured to determine a spray pattern algorithm based on a relationship between the at least one spray gun setting and the spray pattern parameter.

17. The spray control system of claim 16, wherein the feedback device is further configured to receive a coating parameter from a coating analysis device; and the user device is further configured to include the coating parameter in the spray pattern algorithm.

18. The spray control system of claim 17, wherein the coating parameter is a quantitative and/or qualitative metric of a sprayed coating applied to a golf ball.

19. The spray control system of claim 18, wherein the coating parameter is at least one of a coat weight or a coat thickness.

20. The spray control system of claim 17, wherein the user device is configured to determine a spray control algorithm based on a relationship between the at least one spray gun setting, the spray pattern parameter, and the coating parameter.
